(19) United States
(12) Patent Application Publication
(10) Pub. No.: US 2026/0238470 A1
(43) Pub. Date: Aug. 13, 2026

(54) RECEPTION DEVICE, QUANTUM CRYPTOGRAPHY SYSTEM, INFORMATION RECONCILIATION METHOD, AND COMPUTER-READABLE MEDIUM

(71) Applicant: NEC Corporation, Tokyo (JP)

(72) Inventors: Toshihiko OKAMURA, Tokyo (JP); Tetsou KAWAKAMI, Tokyo (JP)

(73) Assignee: NEC Corporation, Tokyo (JP)

(21) Appl. No.: 19/154,800

(22) PCT Filed: Mar. 22, 2023
(86) PCT No.: PCT/JP2023/011127

§ 371 Date: Aug. 8, 2025

(51) Int. Cl. H04L 9/08; H04L 9/06

(52) U.S. Cl. CPC H04L 9/0869; H04L 9/0643

(57) ABSTRACT

A reception device comprises: a quantum communication unit that receives key information, including information from which a shift key is derived; a random number generation unit that generates a random number in which a portion of the key information is compressed on the basis of a characteristic value of noise in the reception of the key information; and an error correction unit that performs information reconciliation on the basis of the random number.

### TECHNICAL FIELD

The present disclosure relates to a reception device, a quantum cryptography system, an information reconciliation method, and a computer-readable medium.

### BACKGROUND ART

PTL 1 and PTL 2 disclose techniques related to key distillation for generating a final key used for cryptographic communication. The key distillation includes information reconciliation (also referred to as error correction) for generating a correction key from a shift key, and confidentiality enhancement for enhancing confidentiality of the correction key.

### CITATION LIST

### Patent Literature

PTL 1: JP 2018-37904 A
PTL 2: JP 2015-99310 A

### SUMMARY OF INVENTION

### Technical Problem

A random number may be required in the information reconciliation. In a case where the random number is generated by using the hardware random number generator, there is a problem that addition of hardware is required.

Therefore, one object to be achieved by the example embodiments disclosed in this specification is to provide a reception device, a quantum cryptography system, an information reconciliation method, and a computer-readable medium for generating a random number used for information reconciliation based on key information.

A reception device according to a first aspect of the present disclosure includes
a quantum communication means for receiving key information including information to be a basis of a shift key,
a random number generation means for generating a random number obtained by compressing a part of the key information based on a characteristic value of noise in reception of the key information, and
an error correction means for performing information reconciliation based on the random number.

A quantum cryptography system according to a second aspect of the present disclosure is a quantum cryptography system including a transmission device and a reception device, in which
the reception device includes
a quantum communication means for receiving key information including information to be a basis of a shift key from the transmission device,
a random number generation means for generating a random number obtained by compressing a part of the key information based on a characteristic value of noise in reception of the key information, and
an error correction means for performing information reconciliation based on the random number.

An information reconciliation method according to a third aspect of the present disclosure includes
receiving key information including information to be a basis of a shift key,
generating a random number obtained by compressing a part of the key information based on a characteristic value of noise in reception of the key information, and
performing information reconciliation based on the random number.

A non-transitory computer-readable medium according to a fourth aspect of the present disclosure stores a program for causing a computer to execute processing of
receiving key information including information to be a basis of a shift key,
generating a random number obtained by compressing a part of the key information based on a characteristic value of noise in reception of the key information, and
performing information reconciliation based on the random number.

### Advantageous Effects of Invention

According to the present disclosure, a reception device, a quantum cryptography system, an information reconciliation method, and a computer-readable medium for generating a random number used for information reconciliation based on key information can be provided.

### BRIEF DESCRIPTION OF DRAWINGS

FIG. 1 is a block diagram illustrating a configuration of a reception device according to a first example embodiment.

FIG. 2 is a block diagram illustrating a configuration of a quantum cryptography system according to a second example embodiment.

FIG. 3 is a diagram describing a modified example of the reception device according to the second example embodiment.

### EXAMPLE EMBODIMENTS

### First Example Embodiment

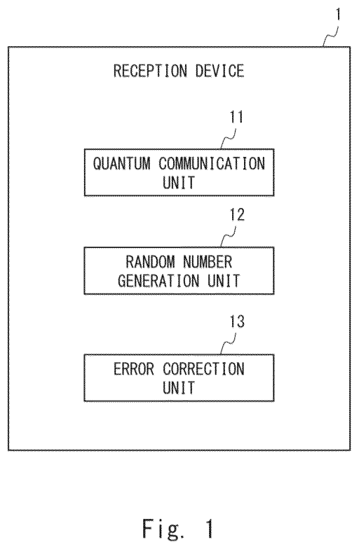

FIG. 1 is a block diagram illustrating a configuration of a reception device 1 according to a first example embodiment. The reception device 1 includes a quantum communication unit 11, a random number generation unit 12, and an error correction unit 13. The reception device 1 is communicably connected to a transmission device (not illustrated) through an optical fiber.

The quantum communication unit 11 receives key information including information to be a basis of a shift key. For example, the quantum communication unit 11 may measure the optical signal modulated based on the key information with the selected basis and convert the measurement signal into digital data.

The random number generation unit 12 generates a random number obtained by compressing a part of the key information based on a characteristic value of noise in the reception of the key information. Specifically, the random number generation unit 12 generates a random number by inputting a part of the key information to the hash function. The compression ratio of the hash function may be defined based on a wiretapping amount calculated from a characteristic value (e.g., variance) of noise.

The error correction unit 13 performs information reconciliation (information reconciliation) based on the random number. Specifically, the error correction unit 13 performs processing called reverse reconciliation. In this case, the error correction unit 13 executes processing of transmitting error correction information to the transmission device based on the random number. The error correction information may be generated based on the random number. Furthermore, in a case where a part of the code of the error correction information is punctured, a random number may be assigned to the part that is not transmitted.

The reception device according to the first example embodiment can generate a random number to be used for information reconciliation based on key information.

The reception device 1 includes a processor, a memory, and a storage device as components (not illustrated). In addition, the storage device stores a computer program in which the processing of the information reconciliation method according to the present example embodiment is implemented. The processor loads the computer program from the storage device into the memory and executes the computer program. As a result, the processor achieves the functions of the quantum communication unit 11, the random number generation unit 12, and the error correction unit 13.

Alternatively, each of the quantum communication unit 11, the random number generation unit 12, and the error correction unit 13 may be achieved by dedicated hardware. Some or all of the components of each device may be implemented by general-purpose or dedicated circuitry, a processor, or a combination thereof. Those components may be configured by a single chip, or may be configured by a plurality of chips connected via a bus. Some or all of the components of each device may be implemented by a combination of the above-described circuitry or the like and a program. As the processor, a Central Processing Unit (CPU), a Graphics Processing Unit (GPU), a Field-Programmable Gate Array (FPGA), or the like can be used.

In a case where some or all of the components of the reception device 1 are implemented by a plurality of information processing devices, circuitry, and the like, the plurality of information processing devices, the circuitry, and the like may be disposed in a centralized manner or in a distributed manner. For example, each of the information processing devices, circuitry, or the like may be implemented in the form of a client server system, a cloud computing system, or the like in which they are connected to each other through a communication network.

### Second Example Embodiment

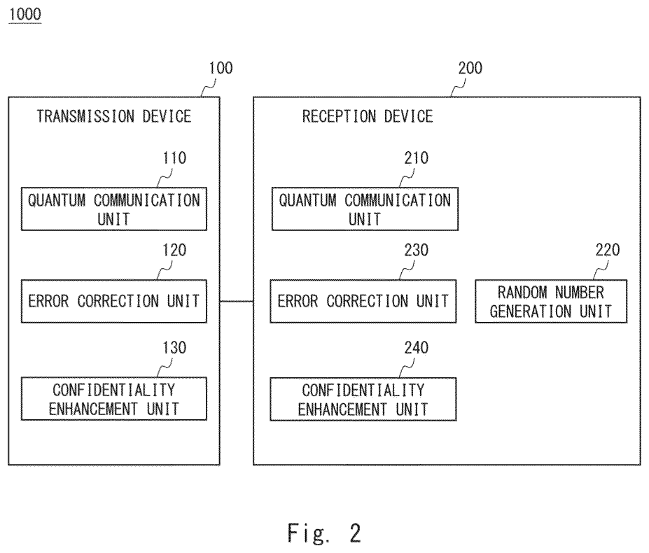

FIG. 2 is a diagram describing a configuration of a quantum cryptography system 1000 according to a second example embodiment. The quantum cryptography system 1000 includes a transmission device 100 and a reception device 200.

Specifically, the quantum cryptography system 1000 uses Continuous-Variable (CV)-Quantum Key Distribution (QKD) as a quantum key distribution protocol. In CV-QKD, for example, weak light having an average number of photons of one photon or less is transmitted, and the weak light is detected by homodyne detection similarly to the normal optical communication. Unlike Discrete Variable (DV)-QKD using a single photon, CV-QKD does not require a special detection device for detecting a single photon. In addition, CV-QKD has an advantage that it can be multiplexed with normal optical communication by the same optical fiber. The quantum key distribution protocol may be BB84 using a single photon.

The transmission device 100 and the reception device 200 are communicably connected through an optical fiber. The optical fiber transmits key information including information to be a basis of a shift key. Furthermore, the transmission device 100 and the reception device 200 are communicably connected through a classical channel (also referred to as a public communication path). The classical channel transmits information on the selected basis and error correction information.

The transmission device 100 includes a quantum communication unit 110, an error correction unit 120, and a confidentiality enhancement unit 130. The error correction unit 120 and the confidentiality enhancement unit 130 perform key distillation.

The quantum communication unit 110 is configured to be able to communicate with the quantum communication unit 210 of the reception device 200. The quantum communication unit 110 transmits the key information to the reception device 200. The quantum communication unit 110 generates, for example, a random bit string as key information, and transmits a weak optical signal modulated based on the random bit string through an optical fiber. At this time, the basis may be randomly selected.

The key information is used to generate a shift key, calculate a characteristic value of noise, and generate a random number for information reconciliation. For example, a lower bit of the key information may be used to generate the random number. In addition, a bit discarded in generating the shift key may be used to generate the random number.

The quantum communication unit 110 generates a shift key based on the information (e.g., information regarding the basis) received from the reception device 200 through the classical channel. There is an error between the shift key generated by the quantum communication unit 110 and the shift key generated by the quantum communication unit 210. In addition, in order for the reception device 200 to calculate the characteristic value of noise, the quantum communication unit 110 may transmit information of a part (e.g., half) of the key information to the reception device 200 through a classical channel. correcting the shift key based on the error correction information received from the reception device 200. By error correction, a common correction key is shared between the transmission device 100 and the reception device 200. In the quantum cryptography system 1000, information reconciliation is performed by a method called reverse reconciliation. In the reverse reconciliation, the error correction information is transmitted from the reception device 200 to the transmission device 100. In CV-QKD, reverse reconciliation is often performed.

The confidentiality enhancement unit 130 compresses the correction key based on the wiretapping amount to generate a final key with enhanced confidentiality of the correction key. The confidentiality enhancement unit 130 may receive the wiretapping amount from the reception device 200 through the classical channel. Furthermore, the confidentiality enhancement unit 130 may receive a random number (e.g., a Toeplitz matrix) for confidentiality enhancement from the reception device 200, and may enhance the confidentiality of the correction key based on the random number.

The reception device 200 includes a quantum communication unit 210, a random number generation unit 220, an error correction unit 230, and a confidentiality enhancement unit 240. The random number generation unit 220, the error correction unit 230, and the confidentiality enhancement unit 240 perform key distillation. The reception device 200 is a specific example of the reception device 1.

The quantum communication unit 210 is a specific example of the quantum communication unit 11. The quantum communication unit 210 measures the optical signal representing the key information transmitted by the transmission device 100 with the selected basis. The quantum communication unit 210 may convert the measurement result into digital data. The quantum communication unit 210 generates a shift key based on the information (e.g., information regarding the basis) received from the transmission device 100 through the classical channel.

The reception device 200 may include a physical random number source for basis selection. However, this physical random number source may be dedicated to basis selection, or it may be difficult to use this physical random number source in information reconciliation.

In addition, the quantum communication unit 210 measures a characteristic value (e.g., variance) of noise in the reception of the key information. The characteristic value is, for example, variance, SN ratio, excess noise, or the like. The quantum communication unit 210 may measure the characteristic value of noise by receiving a part of the key information through the classical channel. Since the estimation accuracy of the characteristic value affects the evaluation of the wiretapping amount, typically, information having a length of about ½ of the length of the shift key may be used for the estimation of the characteristic value.

The random number generation unit 220 is a specific example of the random number generation unit 12. The random number generation unit 220 generates a random number to be used for reverse reconciliation. The random number generation unit 220 receives a part of the key information received by the quantum communication unit 210 and the characteristic value measured by the quantum communication unit 210. The random number generation unit 220 calculates the wiretapping amount based on the characteristic value (e.g., variance). Furthermore, the random number generation unit 220 calculates an entropy h of a part of the key information, that is, information used for random number generation. Then, a part of the key information is compressed at a compression ratio (h-x) obtained by subtracting the wiretapping amount x from the entropy h. The compression ratio represents, for example, a length of a compressed random number.

The random number generation unit 220 compresses a part of the key information by using the first hash function. Specifically, the hash function is expressed by multiplication processing using a randomly selected Toeplitz matrix. The random number generation unit 220 may pass the compression ratio and a part of the key information to the first hash function and receive a random number from the first hash function. The random number generation unit 220 does not need to have a function as the first hash function. The function as the first hash function may be provided in, for example, the confidentiality enhancement unit 240.

The information for random number generation may be secured separately from the information to be a basis of the shift key and the information used for estimating the characteristic value. In addition, there is a possibility that a part of the key information can be used for random number generation due to restriction by performance of key distillation. For example, information of a portion discarded in the post-selection at the time of shift key generation may be used for random number generation. In addition, a lower bit of the soft determination value of the information for estimating the characteristic value may be used for random number generation.

The random number generation unit 220 can generate a true random number or a random number close to the true random number by generating a random number from a part of the key information. The key information is generally randomly generated. Furthermore, by compressing information at a compression ratio related to the wiretapping amount, the random number generation unit 220 can generate a safe random number.

The error correction unit 230 is a specific example of the error correction unit 13. The error correction unit 230 performs reverse reconciliation based on the random number. The error correction unit 230 may transmit error correction information based on a random number to the transmission device 100. Furthermore, in a case where a part of a code (e.g., Multi-Edge Type LCPC code) is punctured, that is, in a case where the part is not transmitted, the error correction unit 230 may assign a random number to a part that is not transmitted.

First, a case where error correction information based on a random number is transmitted will be described. The error correction unit 230 generates a code word using a random number as information, and masks the code word with a shift key. The error correction unit 230 transmits the code word masked with the shift key to the transmission device 100 as the error correction information in a case where the shift key is given in the hard determination {0, 1}. That is, the error correction information Y is represented by Y=Enc(X)+R_{B}. Enc represents encoding, X represents a random number, and RB represents a shift key on the reception side (Bob side). Furthermore, “+” represents XOR. In this case, the correction key X generated on the transmission side (Alice side) is expressed as X=Dec(Y+R_{A})=Dec(Enc(X)+(R_{B}+R_{A})). Dec represents decoding, and R_{A} represents a shift key on the transmission side (Alice side). It is also possible to set the syndrome of (X+R_{B}) and X as the error correction information with X as the same length as the code length.

In the case of soft determination in which the shift key is given by a plus or minus sign representing 0 or 1 of a bit and an absolute value representing reliability, Y is generated by masking Enc(X) with the sign represented by 0 or 1 as in the case of hard determination, and is used as error correction information together with the reliability. At this time, the transmission side (Alice side) performs the processing of the sign portion similarly to the case of the hard determination, and performs decoding together with the information of the reliability.

In a case where multi-dimensional adjustment in CV-QKD of Gaussian modulation is performed, the error correction unit 230 generates a vector of random signal points from Enc(X), and sets a matrix for converting the vector of reception values of the soft determination into the signal points as error correction information. The transmission side (Alice side) obtains a sign and reliability of each bit from a vector obtained by applying the same conversion to the vector of the transmitted signal point, and performs decoding using the same as an input.

Next, a case where a random number is assigned to a portion of the code included in the error correction information that is not transmitted will be described. Depending on the configuration of the code, a part of the code is punctured, so that the efficiency of the code may be improved. The punctured portion is not transmitted. At this time, in the QKD information reconciliation, efficiency can be increased by assigning a random number to the punctured portion in the error correction unit 230. In a case where a syndrome is used for error correction, a syndrome is generated from a data block including a random number of the punctured portion and a shift key (in the case of soft determination, a sign portion thereof). On the reception side (Alice side), the punctured portion is regarded as being disappeared, and decoding is performed by using the syndrome.

The confidentiality enhancement unit 240 generates a final key by compressing the correction key by the second hash function. The correction key is compressed to a length obtained by subtracting an information amount of information used for error correction and an information amount of information estimated to have leaked by quantum communication from a mutual information amount of quantum communication. More specifically describing, the compression ratio r is calculated by r=β*I−χ. I is a mutual information amount between the transmission device 100 and the reception device 200. β is the efficiency of the error correction code. χ is an information amount (also referred to as wiretapping amount) that may be wiretapped in quantum communication. I is determined according to the magnitude of the entire noise. β is determined according to the magnitude and code of the entire noise. χ is calculated according to the magnitude of the entire noise, the transmittance, and the magnitude of noise other than quantum noise (also referred to as excess noise).

Each hash function is a universal hash function. In the universal hash function, more specifically, in the s-universal 2 hash function, in a case where a family H of the hash function is H={h} and the size of the space of the hash value is m, |{h∈H:h(x)=h(y)}|≤ε|H|/m is obtained if the hash values x and y are different. The universal hash function has a property that the number of pieces of original data corresponding to the hash value, that is, the number of related functions is constant. Therefore, if the function is uniformly chosen, it is guaranteed that no more information of the original data will be leaked from the hash value. The universal hash function is typically represented as a multiplication by a randomly generated Toeplitz matrix. The Toeplitz matrix representing the hash function (first hash function) used for random number generation and the Toeplitz matrix defining the hash function (second hash function) used for confidentiality enhancement may be independent of each other. Independent may mean, for example, that two Toeplitz matrices are selected from different hash function families. embodiment may not include the physical random number source for generating the random number. Since true random numbers are required for information theoretical safety, related quantum cryptography systems were equipped with a physical random number source. In the second example embodiment, since a true random number can be obtained by using the received key information, it is not necessary to provide a physical random number source. In addition, since the random number is compressed to a length corresponding to the wiretapping amount, safety of the random number is secured.

A random number does not need to be generated at a high speed as in the case of generating key information or performing basis selection. Furthermore, the random number generation by the hash function is considered to be a relatively light processing. Therefore, an increase in the calculation load is small.

In a case where the error correction information is generated based on the random number, not the entire code word but only the information portion is generated using the random number, so that the necessary length of the random number is small. Furthermore, in a case where a random number is assigned to a portion that is not transmitted, the length of the portion that is not transmitted is at most about 10% of the length of the shift key. In addition, it is also possible to adjust the length of the information to be a basis of the shift key and the length of the information used for random number generation. In this way, since the required length of the random number is short, the random number for information reconciliation may not be generated at a high speed.

In addition, it is known that the processing amount of the random number generation by the hash function is about 1/10 of the processing amount of the decoding processing of error correction. Furthermore, in the reverse reconciliation, the processing amount on the reception side (Bob side) is small as compared with the processing amount on the transmission side (Alice side).

Therefore, even if the processing of random number generation on the reception side (Bob side) is added, the processing performance of the entire quantum cryptography system 1000 is not affected.

The quantum key distribution protocol may be BB84. To describe the BB84 protocol, first, the transmission side randomly selects two types of bases and transmits the key information. Then, the reception side also randomly selects a basis and receives the key information. Communication is possible if the bases match between the transmission side and the reception side, otherwise an error occurs with an establishment of ½. Next, the basis selected on the transmission side and the basis selected on the reception side are collated with each other, and the shift key is generated only from the bit whose bases matched. The bits whose bases do not match are discarded. In a case where the BB84 is used in the second example embodiment, a random number may be generated from information of the bit whose bases do not match.

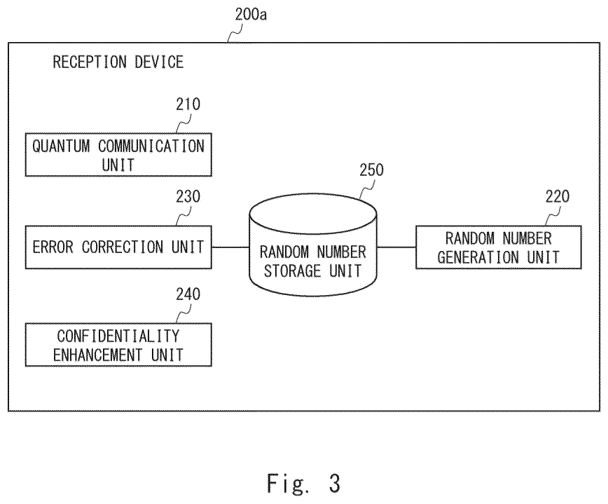

With reference to FIG. 3, it is a block diagram describing a configuration of a reception device 200a according to a modified example of the second example embodiment. Compared with the reception device 200 in FIG. 2, the reception device 200a further includes a random number storage unit 250. The random number storage unit 250 is a storage device such as a hard disk or a flash memory. The random number generation unit 220 accumulates the generated random numbers in the random number storage unit 250. The error correction unit 230 can use the random numbers stored in the random number storage unit 250 at necessary timing.

The above-described program includes a command group (or software codes) for causing a computer to perform one or more functions that have been described in the example embodiments in a case where the program is read by the computer. The program may be stored in a non-transitory computer-readable medium or in a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, and a magnetic cassette, a magnetic tape, a magnetic disk storage, or any other magnetic storage device. The program may be transmitted through a transitory computer-readable medium or a communication medium. By way of example, and not limitation, transitory computer-readable or communication media include electrical, optical, acoustic, or other forms of propagated signals.

While the disclosure of the present application has been particularly shown and described with reference to the example embodiments, the disclosure of the present application is not limited to these example embodiments. It will be understood by those of ordinary skill in the art that various changes in form and details may be made therein without departing from the spirit and scope of the present disclosure as defined by the claims.

### REFERENCE SIGNS LIST

1, 200, 200a reception device
11, 110, 210 quantum communication unit
12, 220 random number generation unit
13, 120, 230 error correction unit
100 transmission device
130, 240 confidentiality enhancement unit
250 random number storage unit
1000 quantum cryptography system

What is claimed is:

1. A reception device comprising:
at least one memory storing instructions and
at least one processor configured to execute the instructions to:
receive key information including information to be a basis of a shift key;
generate a random number obtained by compressing a part of the key information based on a characteristic value of noise in reception of the key information; and
perform information reconciliation based on the random number.

2. The reception device according to claim 1, wherein
the random number is generated by inputting a part of the key information to a first hash function, and
a compression ratio of the first hash function is determined based on a wiretapping amount calculated from the characteristic value of the noise.

3. The reception device according to claim 1, wherein
in the information reconciliation, error correction information is transmitted to a transmission device that transmitted the key information, and
the error correction information includes information in which the random number is masked with the shift key.

4. The reception device according to claim 1, wherein
in the information reconciliation, error correction information is transmitted to a transmission device that transmitted the key information, and
in a case where a part of a code of the error correction information is punctured, the random number is assigned to the part that is not transmitted.

5. The reception device according to claim 2, wherein the at least one processor is further configured to execute the instructions to:
compress a confidentiality of a correction key shared in the information reconciliation by a second hash function,
wherein a Toeplitz matrix representing the first hash function and a Toeplitz matrix representing the second hash function are independent of each other.

6. The reception device according to claim 1, wherein the at least one memory stores the random number.

7. (canceled)

8. (canceled)

9. An information reconciliation method comprising:
receiving key information including information to be a basis of a shift key;
generating a random number obtained by compressing a part of the key information based on a characteristic value of noise in reception of the key information; and
performing information reconciliation based on the random number.

10. A non-transitory computer-readable medium storing a program for causing a computer to execute processing of:
receiving key information including information to be a basis of a shift key;
generating a random number obtained by compressing a part of the key information based on a characteristic value of noise in reception of the key information; and
performing information reconciliation based on the random number.
